(19) United States
(12) Patent Application Publication
(10) Pub. No.: US 2024/0054870 A1
(43) Pub. Date: Feb. 15, 2024

(54) PURCHASE MANAGEMENT SYSTEM, SERVER APPARATUS, PURCHASE MANAGEMENT METHOD, AND RECORDING MEDIUM

(71) Applicant: NEC Corporation, Minato-ku, Tokyo (JP)

(72) Inventors: Rumi IKEZAWA, Tokyo (JP); Manabu HIKIN, Tokyo (JP)

(73) Assignee: NEC Corporation, Minato-ku, Tokyo (JP)

(21) Appl. No.: 17/766,303

(22) PCT Filed: Oct. 12, 2020
(86) PCT No.: PCT/JP2020/038431

§ 371 Date: Apr. 4, 2022

(30) Foreign Application Priority Data
Oct. 21, 2019 (JP) 2019-191751

(51) Int. Cl. G07G 1/00; G06Q 20/20

(52) U.S. Cl. CPC G07G 1/0081; G06Q 20/206

(57) ABSTRACT

A server apparatus creates a list of items to be purchased by receiving item identification information scanned from a code attached to each item, generates checkout information based on the list of items to be purchased, and transmits the list to a mobile terminal. A checkout machine acquires the checkout information from the mobile terminal, and displays an age confirmation screen when an item requiring an age confirmation is included in the list of items to be purchased. The checkout machine completes the age confirmation when acquiring age confirmation information.

### TECHNICAL FIELD

The present disclosure relates to a technical field of a product sales system using a self-register.

### BACKGROUND ART

As a product sales system for a customer who has come to a store to purchase a product, a system is known in which the customer scans a barcode of the product, conducts an item registration, and makes a payment by using a mobile terminal such as a smartphone possessed by the customer. For instance, Patent Document 1 discloses a self-shopping system including a mobile terminal which acquires item information of each of items to be purchased and transmits payment information including all sets of the acquired item information to the management server, and a management server which generates and outputs sort detail information in which item names are listed in descending order of price based on the item information included in the payment information.

Goods sold in stores include alcoholic beverages, cigarettes, and other products, which are prohibited from being sold to persons under a specified age by law. Accordingly, in a case of selling these products, it is necessary to confirm an age of a purchaser. Patent Document 2 describes a method for transmitting a face image of a customer captured at a self-register to a terminal apparatus operated by a clerk and remotely confirming an age of the customer.

### PRECEDING TECHNICAL REFERENCES

### Patent Document

Patent Document 1: Japanese Laid-open Patent Publication No. 2013-41354
Patent Document 2: International Publication Pamphlet No. WO2018/088062

### SUMMARY

### Problem to be Solved by the Invention

However, in a technique of Patent Document 2, a face image of a purchaser to be transmitted to a terminal apparatus of a clerk is a still image, and since a display screen of the terminal apparatus of the clerk is not so large, it may occur that the clerk cannot correctly confirm an age based on the transmitted face image. Also, since the face image of the purchaser is taken by a camera provided in a self-register, a face image of the customer cannot be captured well unless the purchaser faces the camera and cooperates in shooting.

An object of the present disclosure is to perform an age confirmation correctly in a purchase management system using a self-register.

### Means for Solving the Problem

According to an example aspect of the present disclosure, there is provided a purchase management system including:
a server apparatus; and
a checkout machine,
wherein the server apparatus includes
   an item identification information acquisition unit configured to receive item identification information, which is scanned from a code attached to each item, from a mobile terminal,
   a list creation unit configured to create a list of items to be purchased based on the item identification information received from the mobile terminal, and
   a checkout information generation unit configured to generate checkout information based on the list of items to be purchased and transmit the checkout information to the mobile terminal, and wherein the checkout machine includes
   a list acquisition unit configured to acquire the checkout information from the mobile terminal, and acquire the list of items to be purchased based on the checkout information,
   a display control unit configured to display an age confirmation screen when an item requiring an age confirmation is included in the list of items to be purchased,
   an age confirmation information acquisition unit configured to acquire age confirmation information, and
   an age confirmation unit configured to complete the age confirmation when the age confirmation information is acquired by the age confirmation information acquisition unit.

According to another example aspect of the present disclosure, there is provided a purchase management method performed by a purchase management system including a server apparatus and a checkout machine,
wherein the server apparatus performs
   receiving item identification information, which is scanned from a code attached to each item, from a mobile terminal,
   creating a list of items to be purchased based on the item identification information received from the mobile terminal, and
   generating checkout information based on the list of items to be purchased, and transmitting the checkout information to the mobile terminal, and
wherein the checkout machine performs
   acquiring the checkout information from the mobile terminal, and acquiring the list of items to be purchased based on the checkout information,
   displaying an age confirmation screen when an item requiring an age confirmation is included in the list of items to be purchased,
   acquiring age confirmation information, and
   completing the age confirmation when the age confirmation information is acquired.

According to still another example aspect of the present disclosure, there is provided a server apparatus capable of communicating with a mobile terminal and a checkout machine, the server apparatus including:
an item identification information acquisition unit configured to receive item identification information scanned from a code attached to each item, from the mobile terminal;
a list creation unit configured to create a list of items to be purchased based on the item identification information received from the mobile terminal;
a checkout information generation unit configured to generate checkout information based on the list of items to be purchased, and transmit the checkout information to the mobile terminal;
a list acquisition unit configured to receive checkout information from the checkout machine, and acquire the list of items to be purchased based on the checkout information;
a display control unit configured to display an age confirmation screen on the checkout machine when an item requiring an age confirmation is included in the list of items to be purchased;
an age confirmation unit configured to complete the age confirmation when age confirmation information is received from the checkout machine.

According to a further example aspect of the present disclosure, there is provided a recording medium storing a program, the program causing a computer to perform a process comprising:
receiving item identification information scanned from a code attached to each item, from a mobile terminal;
creating a list of items to be purchased based on the item identification information received from the mobile terminal;
generating checkout information based on the list of items to be purchased and transmitting the checkout information to the mobile terminal;
receiving checkout information from a checkout machine, and acquiring the list of items to be purchased;
displaying an age confirmation screen on the checkout machine when an item requiring an age confirmation is included in the list of items to be purchased;
completing the age confirmation when age confirmation information is received from the checkout machine.

### Effect of the Invention

According to the present disclosure, it is possible to correctly perform an age confirmation in a purchase management system using a self-register.

### BRIEF DESCRIPTION OF THE DRAWINGS

FIG. 1 illustrates a purchase management system according to example embodiments.

FIG. 2 illustrates a schematic configuration of a POS server.

FIG. 3 illustrates a schematic configuration of a management server.

FIG. 4 illustrates a schematic configuration of a mobile terminal.

FIG. 5 illustrates a schematic configuration of a checkout machine.

FIG. 6 is a flowchart of a product purchase process.

FIG. 7 is a flowchart of a store entry process.

FIG. 8 is a flowchart of an item selection process

FIG. 9 illustrates a display example of an items-to-be-purchased list screen.

FIG. 10 is a flowchart of a checkout process.

FIG. 11 illustrates a display example of a payment screen.

FIG. 12A and FIG. 12B illustrate display examples of a payment method selection screen and a checkout end screen.

FIG. 13 is a flowchart of a checkout process of a first example embodiment.

FIG. 14 illustrates a display example of an age confirmation screen.

FIG. 15 is a flowchart of a checkout process of a second example embodiment.

FIG. 16A and FIG. 16B illustrates display examples of a payment screen of the second example embodiment.

### EXAMPLE EMBODIMENTS

In the following, example embodiments will be described with reference to the accompanying drawings.

[Configuration of the Purchase Management System]

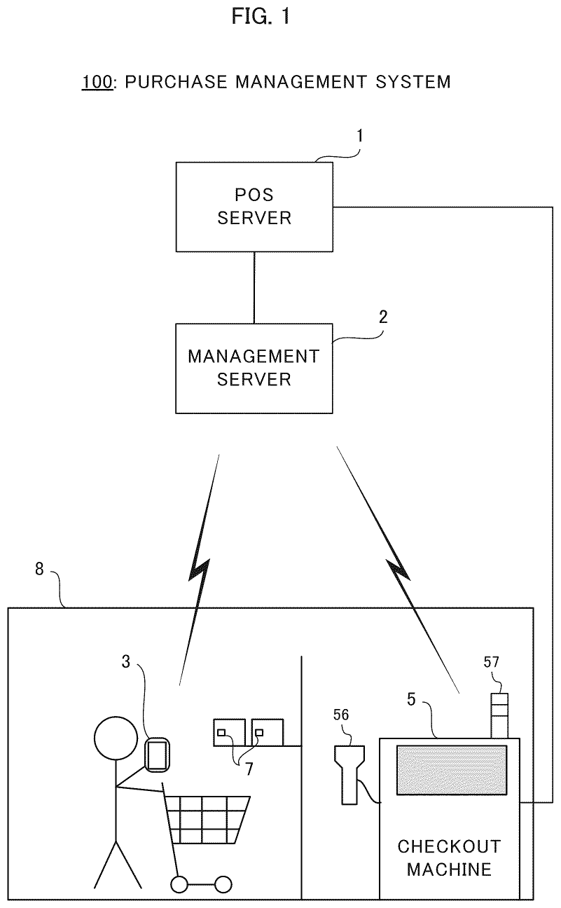

FIG. 1 illustrates a configuration of a purchase management system 100 according to a present example embodiment. The purchase management system 100 mainly includes a POS server 1, a management server 2, a mobile terminal 3, and a checkout machine 5. In the purchase management system 100, a customer using the mobile terminal 3 performs registration of items to be purchased (also referred to as a “items-to-be-purchased”) by scanning an item barcode 7 attached to each item in a store 8 for selling goods, and makes a payment using the checkout machine 5 in the store 8 or by an electronic payment.

The POS server 1 is a server that manages various sales information such as prices concerning goods for sale in the store 8, product information including an inventory status, and the like. The POS server 1 can communicate with the management server 2 and the checkout machine 5 via a network or the like. Incidentally, the POS server 1 may be one that collectively manages sales information of a plurality of affiliated stores, or may be present for each store and manage only the sales information of the store.

Management server 2 is a server apparatus for controlling the mobile terminal 3 and the checkout machine 5, and can communicate with the mobile terminal 3 and the checkout machine 5 via a network or the like. The management server 2 acquires and stores information necessary for display controls of the mobile terminal 3 from the POS server 1. The management server 2 transmits display information to the mobile terminal 3 in order to display various screens on the mobile terminal 3. The above-described various screens include a screen (also referred to as a “items-to-be-purchased list screen”) for displaying, with a selling price, a list of items to be purchased (referred to as a “items-to-be-purchased list”), which are registered by the mobile terminal 3 scanning the item barcode 7.

The management server 2 may be formed by a plurality of server apparatuses. For instance, the management server 2 may include a server apparatus, which mainly performs an interface operation with the mobile terminal 3 such as data exchanges with the mobile terminal 3, and a server apparatus, which stores and manages information acquired from the POS server 1 and various information such as the items-to-be-purchased list and the like. In this case, the former server apparatus functions as a so-called application server, and the latter server apparatus functions as a so-called database server. In this case, these server apparatuses exchange information necessary for each to execute an allocated process via a network or the like.

The mobile terminal 3 is a mobile terminal used by a customer shopping at the shop 8, and includes a function of scanning the item barcode 7 attached to each item, a function of acquiring and displaying various screens such as an items-to-be-purchased list screen by communicating with the management server 2, and the like. Incidentally, in FIG. 1, for convenience of explanation, only one mobile terminal 3 is depicted; however, actually, the mobile terminals 3 for the number of customers entering the store 8 are represented.

The checkout machine 5 is a payment machine (so-called self-checkout machine) for a customer to perform payment using the mobile terminal 3. The checkout machine 5 is capable of communicating with the management server 2, and transmits and receives various information necessary for a payment with the management server 2 and the POS server 1 as necessary. The checkout machine 5 includes a barcode reader 56 for scanning a checkout barcode, which will be described later, from the mobile terminal 3 of the customer, and a light 57 for calling a clerk.

[Configurations of Apparatuses]

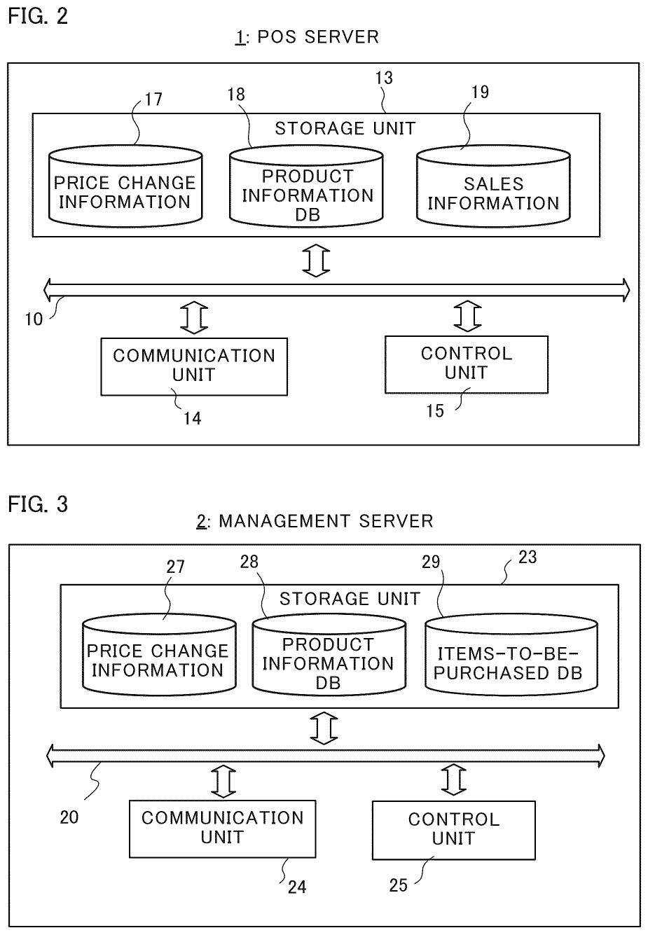

Next, configurations of the POS server 1, the management server 2, the mobile terminal 3, and the checkout machine 5 will be described with reference to FIG. 2 to FIG. 5.

(POS Server)

FIG. 2 illustrates a schematic configuration of the POS server 1. The POS server 1 mainly includes a storage unit 13, a communication unit 14 for performing data communication, and a control unit 15. These elements are mutually connected via a bus line 10.

The storage unit 13 is formed by a memory such as a hard disk or a flash memory. The storage unit 13 stores a program to be executed by the control unit 15, and the information necessary for the control unit 15 to execute a predetermined process by executing a program. In the present example embodiment, the storage unit 13 includes a price change information 17, a product information DB (Database) 18, and sales information 19 being information related to sales of goods. Incidentally, the storage unit 13 may store information related to various sales other than the price change information 17, the product information DB 18, and the sales information 19.

The product information DB 18 is a database of information concerning the goods handled by the store 8 or affiliated stores including the store 8. The product information DB 18 includes, for instance, various information such as information (also referred to as “item identification information”) for identifying goods such as a product price and a JAN (Japanese Article Number) code, classification information of a product, an inventory status of the product, and the like. Incidentally, for items such as alcoholic beverages and cigarettes (hereinafter referred to as an “age confirmation item”), which cannot be sold to persons under the specified age by law, a specific code or the like, which indicates such a type of an item, is applied to the item identification information, so as to be possible to determine whether or not the item is an age confirmation item by referring to the item identification information.

The price change information 17 is information related to a price change. Specifically, the price change information 17 includes at least one of arbitrary discount information or discount information such as classification specific sales discount information, bundle discount information, set discount information, total discount information, and classification specific price discount information.

The control unit 15 includes a CPU (Central Processing Unit) (not illustrated), a ROM (Read Only Memory) and a RAM (Random Access Memory), and the like, and performs various controls with respect to each of configuration elements in the POS server 1. For instance, the control unit 15 performs an update or the like of the sales information 19 by communicating with the checkout machine 5 via the communication unit 14. Also, the control unit 15 transmits information related to the price change information 17 and the product information DB 18 to the management server 2 by communicating with the management server 2 via the communication unit 14.

(Management Server)

FIG. 3 illustrates a schematic configuration of the management server 2. The management server 2 mainly includes a storage unit 23, a communication unit 24, and a control unit 25. These elements are mutually connected to each other via a bus line 20.

The storage unit 23 is formed by a memory such as a hard disk or a flash memory. The storage unit 23 stores a program to be executed by the control unit 25, and the information necessary for the control unit 25 to execute a predetermined process by executing a program. In the present example embodiment, the storage unit 23 stores a price change information 27, a product information DB 28, and an items-to-be-purchased list DB 29.

The price change information 27 is information related to a change in the price due to a price discount or a sales discount, similar to the price change information 17. The price change information 27 is periodically or irregularly updated in accordance with controls of the control unit 25, so as to synchronize with the price change information 17 stored in the POS server 1. The product information DB 28 is a database of information concerning goods, similar to the product information DB 18. The product information DB 28 is periodically or irregularly updated to synchronize with the product information DB 18 stored in the POS server 1 in accordance with controls of the control unit 25.

The items-to-be-purchased list DB 29 is a database of items-to-be-purchased lists for each of the mobile terminals 3 of customers who are shopping at stores 8. For instance, the items-to-be-purchased list is regarded as a list which includes item identification information indicating an item to be purchased, and a quantity of the item to be purchased, and is associated with information (referred to as “customer identification information”), which identifies the mobile terminal 3 or the customer using the mobile terminal 3. In addition, the items-to-be-purchased list is updated every time an addition, a deletion, or a quantity change of the items-to-be-purchased occurs based on the operation of the mobile terminal 3.

The communication unit 24 communicates with the POS server 1, the mobile terminal 3, and the checkout machine 5 through wired or wireless communications. The control unit 25 includes a CPU, a ROM and a RAM, and the like, which are not illustrated, and performs various controls with respect to each of configuration elements in the management server 2. Processes executed by the control unit 25 will be described later. In the above configuration, the communication unit 24 is an example of an item identification information acquisition unit, and the control unit 25 corresponds to examples of a list creation unit, a list acquisition unit, a checkout information generation unit, a checkout screen information generation unit, a display control unit, and an age confirmation unit.

(Mobile Terminal)

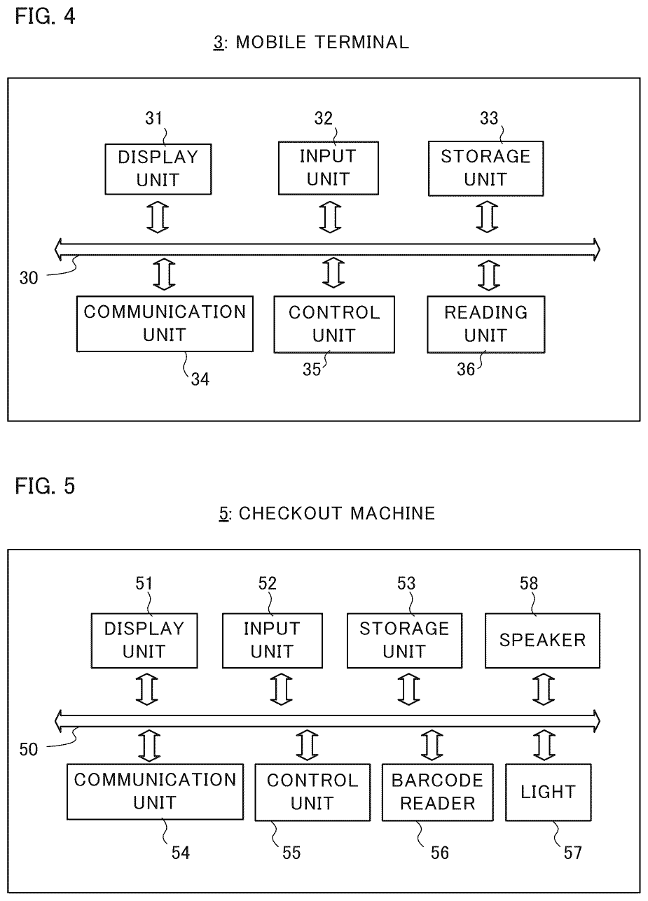

FIG. 4 illustrates a schematic configuration of the mobile terminal 3. The mobile terminal 3 mainly includes a display unit 31, an input unit 32, a storage unit 33, a communication unit 34, a control unit 35, and a scan unit 36. These elements are mutually connected to each other via a bus line 30.

The display unit 31 displays various information such as an items-to-be-purchased list, a checkout barcode, or the like in accordance with controls of the control unit 35. The input unit 32 is an interface to accept an input from a user, and corresponds to, for instance, a touch panel, a button, a voice input device, or the like.

The storage unit 33 is formed by a memory such as a hard disk or a flash memory. The storage unit 33 stores a program to be executed by the control unit 35, and information necessary for the control unit 35 to perform a predetermined process by executing a program. For instance, the storage unit 33 stores a dedicated application program, which is started when shopping is performed at the shop 8 and which controls a display of various screens such as an items-to-be-purchased list screen and the like.

The communication unit 34 communicates with the management server 2 through wireless communications. The control unit 35 includes a CPU, a ROM and a RAM, and the like, which are not illustrated, and performs various controls for each of configuration elements in the mobile terminal 3. Controls conducted by the control unit 35 will be described later.

The scan unit 36 is, for instance, an optical device such as a camera, scans the item barcode 7 attached to each item, and supplies the scan information to the control unit 35. In the present example embodiment, the control unit 35 acquires item identification information such as the JAN code from the item barcode 7 attached to each item based on information output by the scan unit 36.

(Checkout Machine)

FIG. 5 illustrates a schematic configuration of the checkout machine 5. The checkout machine 5 mainly includes a display unit 51, an input unit 52, a storage unit 53, a communication unit 54, a control unit 55, a barcode reader 56, a light 57, and a speaker 58. These elements are mutually connected to each other via a bus line 50.

The display unit 51 performs a display of various information such as a payment method selection screen and an end screen based on controls of the control unit 55. The input unit 52 is an interface, which accepts an input from a customer and corresponds to, for instance, a touch panel, a button, or the like.

The storage unit 53 is formed by a memory such as a hard disk or a flash memory. The storage unit 53 stores a program to be executed by the control unit 55, and information necessary for the control unit 55 to conduct a predetermined process by executing a program. For instance, the storage unit 53 stores a dedicated application program for performing a checkout process when the customer makes a payment.

The control unit 55 includes a CPU, a ROM and a RAM, and the like, which are not illustrated, and performs various controls for each of configuration elements in the checkout machine 5. Controls performed by the control unit 55 will be described later. The barcode reader 56 scans the checkout barcode displayed on the mobile terminal 3 of the customer when the customer makes a payment, and supplies the scan information to the control unit 55. The light 57 is turned on in a case where a problem occurs in the checkout machine 5, in a case of calling a clerk, or the like. The speaker 58 outputs an operation sound or a voice message for attention as necessary. Note that in the above configuration, the control unit 55 corresponds to examples of a list acquisition unit, a display control unit, and an age confirmation unit, and the barcode reader 56 is an example of an age confirmation information acquisition unit.

[Product Purchase Process]

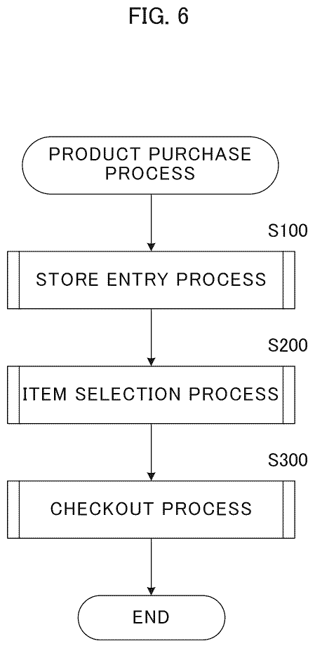

Next, an outline of a product purchase process by the purchase management system 100 will be described. The product purchase process is a process in which a customer purchases a product using the mobile terminal 3 in the store 8. FIG. 6 is a flowchart illustrating an outline of the product purchase process. The product purchase process is roughly divided into a store entry process S100, an item selection process S200, and a checkout process S300. Note that the product purchase process is realized by mainly the management server 2, the mobile terminal 3 and the checkout machine 5 executing respective programs prepared in advance.

(Store Entry Process)

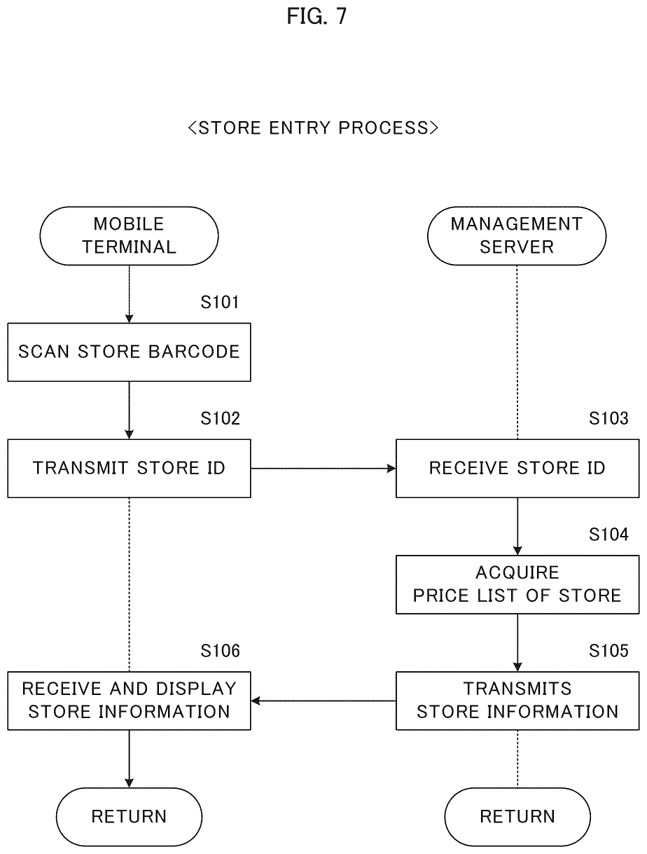

First, a store entry process will be described. The store entry process is a process, which is performed prior to a purchase of a product, when a customer enters the store 8, which corresponds to preparation for the purchase of the product. FIG. 7 is a flowchart illustrating an example of the store entry process. The store entry process is performed by the mobile terminal 3 and the management server 2.

First, when the customer enters the store 8, the customer scans a store barcode using the mobile terminal 3 (step S101). The store barcode is attached at a predetermined location in the store 8, for instance, a wall near an entrance of the store or a card used for shopping. When the customer scans the store barcode, the mobile terminal 3 acquires the store ID from the scanned store barcode and transmits the store ID to the management server (step S102). In a case of transmitting a store ID, the mobile terminal 3 transmits the customer identification information, which identifies the mobile terminal 3 or the customer using the mobile terminal 3, together with the store ID. Noted that even in the item selection process and the checkout process described below, when the mobile terminal 3 basically transmits some information to the management server 2, the mobile terminal 3 transmits the customer identification information for identifying itself with the information.

The management server 2 receives the store ID from the mobile terminal 3 (step S103) and acquires a price list of the store from the product information DB 28 (step S104). This is because prices of goods differ for each store. After that, the management server 2 transmits store information including a store name and sale information of the store to the mobile terminal 3 (step S105), and the mobile terminal 3 receives the store information (step S106). By this store entry process, a current store name, the sale information of the store, and the like are displayed on the display unit 31 of the mobile terminal 3, and the customer can start shopping. The store information, which the management server 2 sends, includes information indicating a transaction status of the customer in the store, and the transaction status becomes new when a new shopping is started at the store. On the other hand, in a case where the customer has interrupted shopping at the store for some reason, an items-to-be-purchased list screen corresponding to the transaction status up to that point is displayed on the mobile terminal 3.

(Product Selection Process)

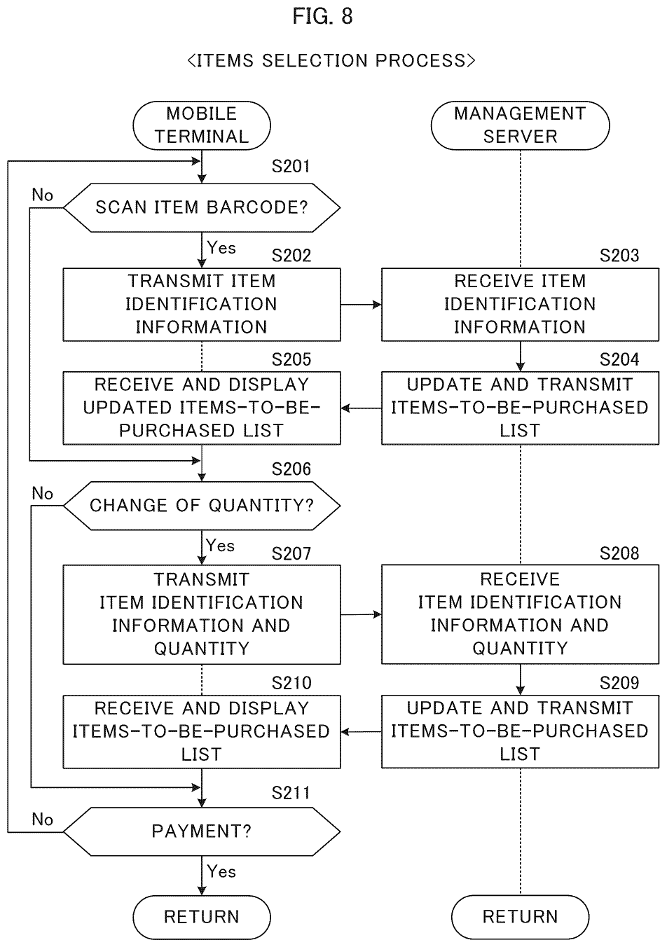

Next, an item selection process will be described. The item selection process is a process in which the customer scans the item barcode 7 attached to each item using the mobile terminal 3 and registers item information in the items-to-be-purchased list. FIG. 8 is a flowchart of the item selection process. This process is executed by the mobile terminal 3 and the management server 2.

First, when a customer finds an item desired to purchase, the customer sets the mobile terminal 3 to an item scan mode, and scans the item barcode 7 attached to the item by the mobile terminal 3 (step S201: Yes). The mobile terminal 3 transmits item identification information of the scanned item to the management server 2 (step S202). At this time, a quantity of the item is automatically set to “1”. When receiving the item identification information from the mobile terminal 3 (step S203), the management server 2 updates and transmits the items-to-be-purchased list to the mobile terminal 3 (step S204). The mobile terminal 3 receives and displays the updated items-to-be-purchased list on the display unit 31 (step S205). Accordingly, newly added items and respective quantities are additionally recorded to the items-to-be-purchased list and displayed on the mobile terminal 3.

Next, when the customer operates the mobile terminal 3 to change a quantity of the item as needed, the mobile terminal 3 acquires the changed quantities (S206 of steps: Yes). When an item barcode is first scanned, the quantity of that product is automatically set to be “1”; however, in a case where a customer purchases multiple same items, the quantity can be changed upon operating the mobile terminal 3. When the changed quantity is set, the mobile terminal 3 transmits the item identification information of the item to be changed and the changed quantity to the management server 2 (step S207).

When receiving the item identification information and the changed quantity from the mobile terminal 3 (step S208), the management server 2 updates the items-to-be-purchased list and transmits the items-to-be-purchased list to the mobile terminal 3 (step S209). The mobile terminal 3 receives the updated items-to-be-purchased list and displays the updated items-to-be-purchased list on the display unit 31 (S210 of steps). Accordingly, the change in quantity is reflected in the items-to-be-purchased list.

Next, the mobile terminal 3 determines whether a payment button 45 is pressed by the customer (step S211). The payment button 45 is a button to be pushed when the customer finishes shopping. If the payment button 45 is not pressed (step S211: No), the item selection process returns to step 201. Accordingly, until the payment button 45 is pressed, the customer can add an item or change the quantity, and continue shopping. After that, when the payment button 45 is pressed (step S211: Yes), the item selection process is terminated.

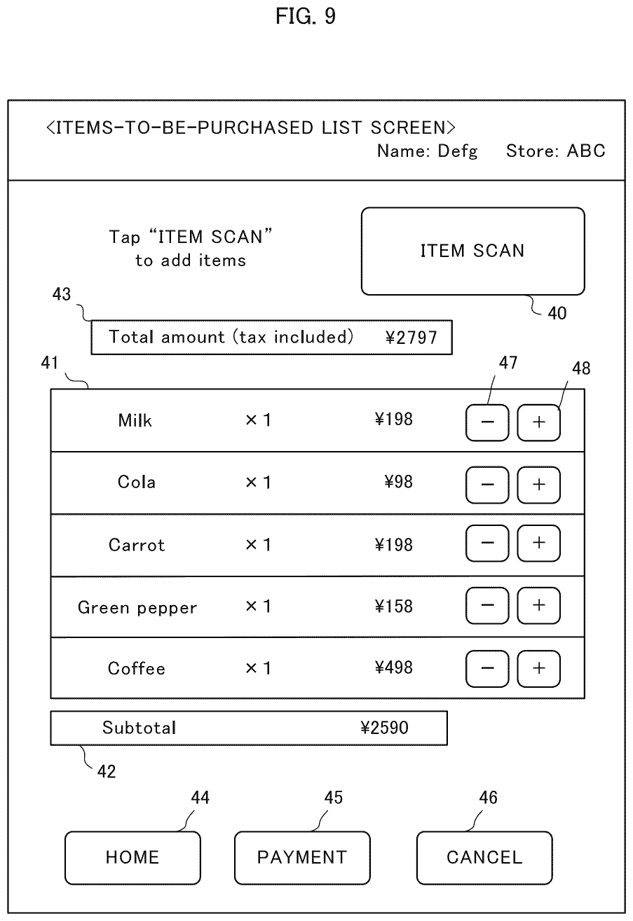

FIG. 9 illustrates a display example of the items-to-be-purchased list screen displayed on the mobile terminal 3. In this example, the items-to-be-purchased list screen includes an item scan button 40, a list display column 41, a subtotal display column 42, a total amount display column 43, a home screen transition button 44, a payment button 45, and a transaction cancel button 46.

When detecting that the item scan button 40 is selected by a tap operation or the like, the mobile terminal 3 switches a display of the display unit 31 to the item scan screen. In the item scan screen, the mobile terminal 3 displays an image or the like acquired from the started scan unit 36. Accordingly, the customer moves the item or the mobile terminal 3 so that the item barcode 7 is positioned within a scan range of the scan unit 36, and scans the item barcode 7.

For each of the items-to-be-purchased, a name, a quantity, and a price of the items-to-be-purchased are displayed in the list display column 41. Also, for each of the items-to-be-purchased in the list display column 41, a quantity decrease button 47, and a quantity increase button 48 are displayed. After that, in a case where the mobile terminal 3 receives a quantity change for the items-to-be-purchased by an operation of the quantity decrease button 47 or the quantity increase button 48, and the mobile terminal 3 transmits the item identification information of the items-to-be-purchased for which a quantity has been changed, and the changed quantity to the management server 2.

The subtotal display column 42 displays a subtotal amount without tax with respect to selling prices for all items in the items-to-be-purchased list, and the total amount display column 43 displays a total amount including tax with respect to the selling prices for all items in the items-to-be-purchased list. The management server 2 calculates the subtotal amount or the total amount based on prices of items-to-be-purchased registered in the product information DB 28, specifically, a selling price list of the store acquired by the store entry process.

When detecting that the home screen transition button 44 is selected, the mobile terminal 3 transmits a display request of a home screen to the management server 2 and displays a predetermined home screen based on display information received as the response. The home screen may be one that displays a discount at the store 8 and discount information, registration information of a customer of the mobile terminal 3, and the like.

When detecting that the payment button 45 is selected, the mobile terminal 3 transmits a checkout request to the management server 2, and displays a payment screen including a checkout barcode, which will be described later, based on the display information to receive as a response. Also, when detecting that the transaction cancel button 46 has been selected, the mobile terminal 3 transmits information to report a transaction cancel to the management server 2. In this case, the management server 2 deletes the items-to-be-purchased list corresponding to the mobile terminal 3.

(Checkout Process)

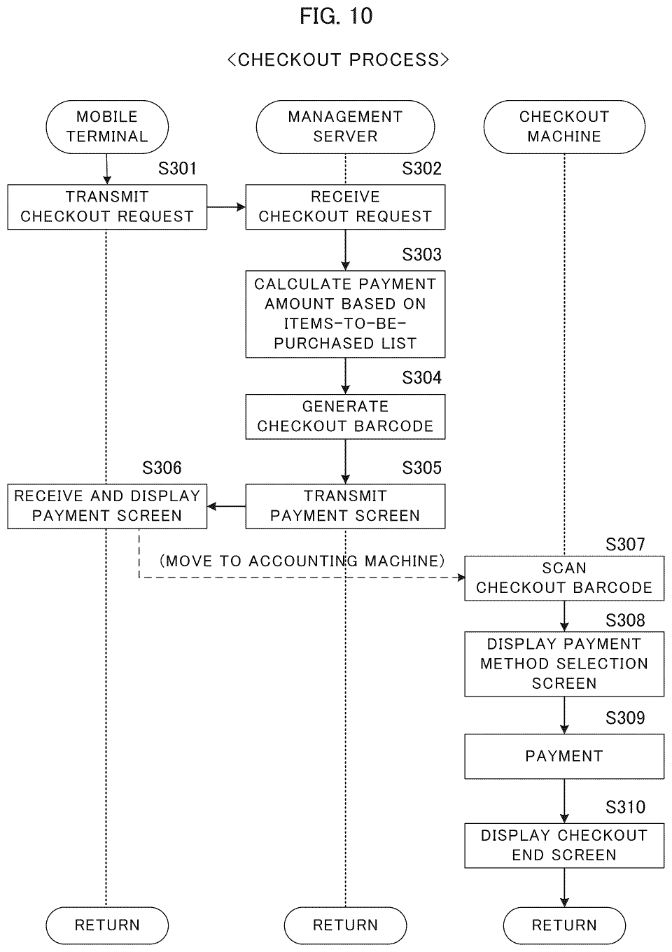

Next, a checkout process will be described. The checkout process is a process for paying items selected by the customer through the item selection process. FIG. 10 is a flowchart of the checkout process. This checkout process is executed by the mobile terminal 3, the management server 2, and the checkout machine 5.

First, when the payment button 45 described above is pressed, the mobile terminal 3 transmits a checkout request to the management server 2 (step S301). Upon receiving the checkout request (step S302), the management server 2 calculates a payment amount based on the items-to-be-purchased list at that time (step S303). Moreover, the management server 2 generates a checkout barcode (step S304). The checkout barcode is information that uniquely identifies purchase contents indicated by the current items-to-be-purchased list. In one example, the checkout barcode can be a random code or the like uniquely associated with the purchase contents at that time. In this case, the checkout barcode has a meaning as an inquiry number of payment information. The management server 2 transmits a payment screen including the payment amount calculated by the step S303 and the checkout barcode generated by the step S304 to the mobile terminal 3 (step S305).

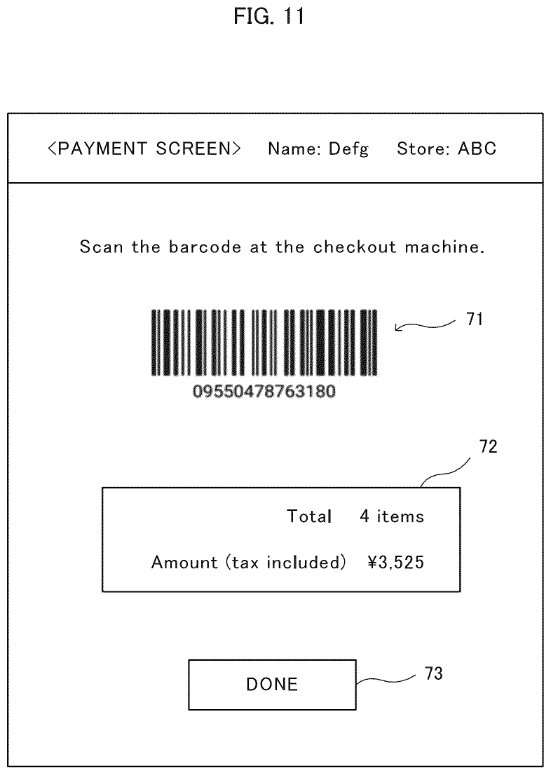

The mobile terminal 3 displays the received payment screen on the display unit 31 (step S306). FIG. 11 is a display example of the payment screen. In this example, the payment screen includes a checkout barcode 71, a total amount column 72, and a done button 73. The customer moves to the checkout machine 5 with the mobile terminal 3 on which the payment screen is displayed, and scans the checkout barcode by the barcode reader 56 (step S307). The checkout machine 5 displays the payment method selection screen based on the scanned checkout barcode (step S308). Specifically, the checkout machine 5 transmits the inquiry number indicated by the checkout barcode to the management server 2, and acquires the payment information from the management server 2. Incidentally, the payment information includes the total amount, and details such as IDs and quantities of all items indicated in the items-to-be-purchased list. The checkout machine 5 displays the payment method selection screen based on the acquired payment information.

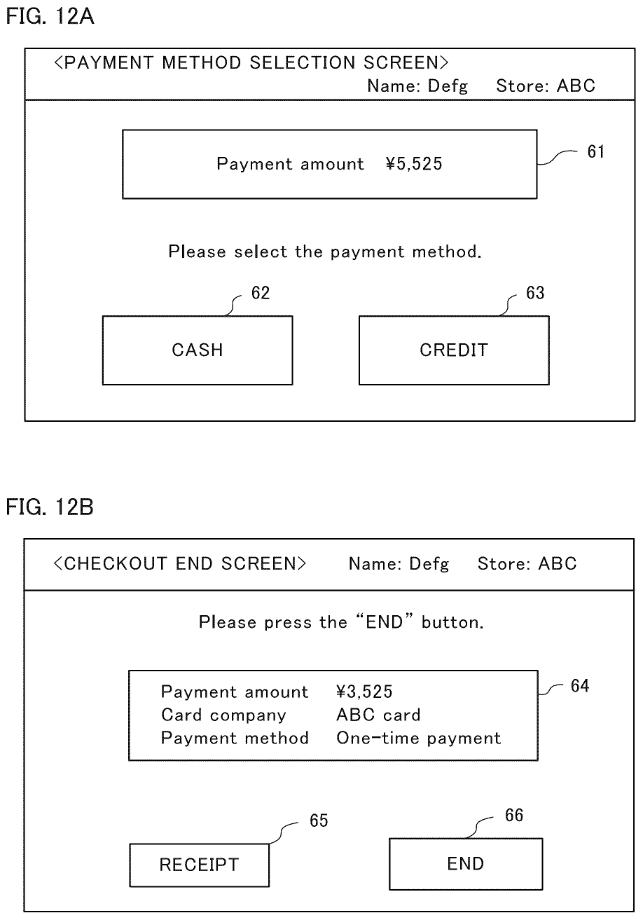

FIG. 12A illustrates a display example of the payment method selection screen. The payment method selection screen includes a total amount column 61, a cash button 62, and a credit button 63. The customer confirms a payment amount by looking at the payment method selection screen, and presses either the cash button 62 or the credit button 63 to make the payment. By this operation, the payment is settled (step S309). Specifically, in a case where the customer selects to make a payment in cash, the checkout machine 5 prompts the cash to be put into a cash slot, and when the cash is put in, changes are paid if needed. In a case where the customer selects to pay by credit, the checkout machine 5 prompts to insert a card, prompts to input a personal identification number or the like as necessary, and makes a credit payment.

When the payment is completed, the checkout machine 5 displays a checkout end screen (step S310). FIG. 12B illustrates a display example of the checkout end screen. FIG. 12B illustrates a case example where a customer selects a credit payment, and the checkout end screen includes a payment information column 64, a receipt button 65, and an end button 66. The payment information column 64 displays information such as a payment amount, a payment method, and the like. The receipt button 65 is a button for printing out the receipt. The end button 66 is a button for confirming that the customer has completed the checkout process. When the customer presses the end button 66, the checkout machine 5 reports that the payment has been completed to the management server 2, and returns the display of the display unit 51 to a main menu. Incidentally, as illustrated in FIG. 11, the done button 73 is also displayed on the payment screen displayed on the mobile terminal 3, the customer presses the done button 73 on the payment screen when the checkout process is completed. When the done button 73 is pressed, the mobile terminal 3 reports that the payment has been completed to the management server 2, and returns the display unit 31 to the main menu.

In the above example, the checkout barcode is merely the inquiry number of the payment information, and the checkout machine 5 obtains the payment information from the management server 2 using the inquiry number. Alternatively, the checkout barcode may include payment information. That is, when receiving a checkout request, the management server 2 generates a checkout barcode using information of the total amount and the items-to-be-purchased list based on contents of the items-to-be-purchased list at that time. In this case, since by scanning and decoding the checkout barcode, the checkout machine 5 can acquire the payment information, there is no need to communicate with the management server 2 to obtain the payment information. That is, the checkout machine 5 may extract a total amount from the scanned checkout barcode, and display the payment method selection screen.

[Age Confirmation]

Next, an age confirmation in the purchase management system of the present example embodiment will be described. Goods sold at stores include an age confirmation item that cannot be sold to persons below a predetermined age by law, such as alcoholic beverages, cigarettes, and the like. Accordingly, in a case where the items-to-be-purchased by the customer includes the age confirmation item, an age confirmation must be performed at a time of a checkout. In this example embodiment, the age confirmation is performed by the checkout machine 5. Incidentally, it is determined based on the item identification information whether or not an age confirmation item is included. Specifically, in a first method, for each age confirmation item, a specific code is included in the item identification information. The management server 2 and the checkout machine 5 may store the specific code indicating the age confirmation item, refer to the item identification information of the items-to-be-purchased, and determine that the item corresponds to the age confirmation item when the specific code is included. In a second method, a list of the item identification information of the age confirmation item (hereinafter referred to as the “age confirmation item list”) is prepared in advance. The management server 2 and the checkout machine 5 store the age confirmation item list in advance, refer to the age confirmation item list, and determine that the item to be purchased corresponds to the age confirmation item when the item identification information of the item to be purchased is included in an age confirmation item list.

### First Example Embodiment

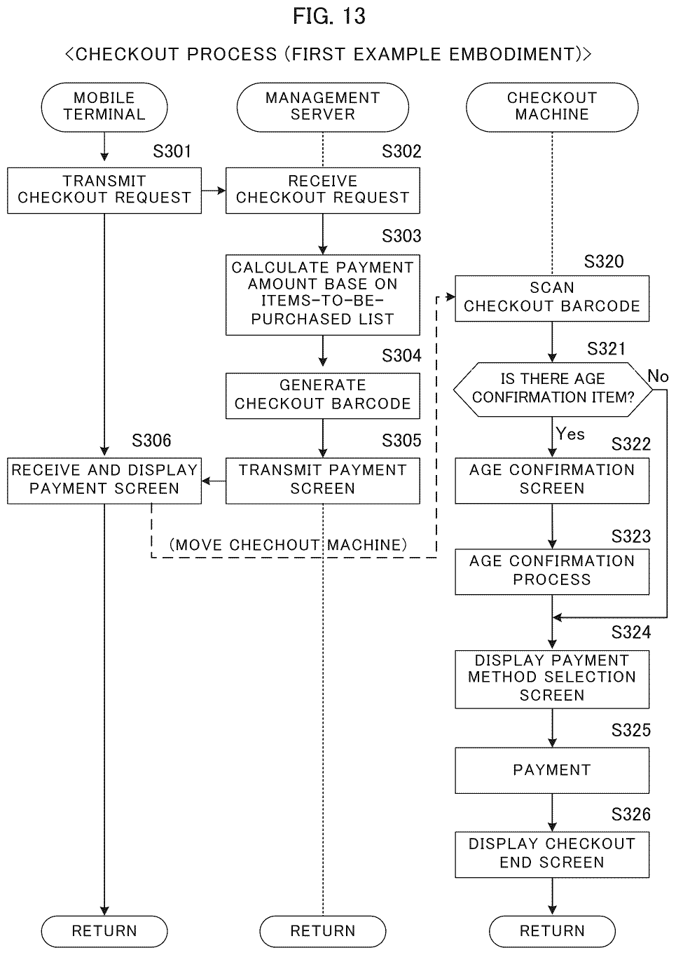

In the first example embodiment, it is assumed a case of conducting a checkout process by a customer using the checkout machine 5. In this case, the customer basically accounts for items to be purchased through the checkout process illustrated in FIG. 10. However, in a case where the items to be purchased includes an age confirmation item, it is necessary to confirm the age by the checkout machine 5. FIG. 13 illustrates a flowchart of the checkout process in a case of performing an age confirmation.

In FIG. 13, processes of the steps S301 through S306 are the same as those depicted in FIG. 10, and explanations thereof will be omitted. When the payment screen is displayed on the mobile terminal 3 in the step S306, the customer scans the checkout barcode 71 of the payment screen on the checkout machine 5 (step S320). The checkout barcode 71 is an example of checkout information. When scanning the checkout barcode 71, the checkout machine 5 acquires payment information. Incidentally, as described above, when the checkout barcode 71 is an inquiry number, the checkout machine 5 transmits the checkout barcode 71 to the management server 2, and acquires the payment information from the management server 2. On the other hand, when the payment information is included in the checkout barcode 71, the checkout machine 5 acquires the payment information by decoding the checkout barcode 71.

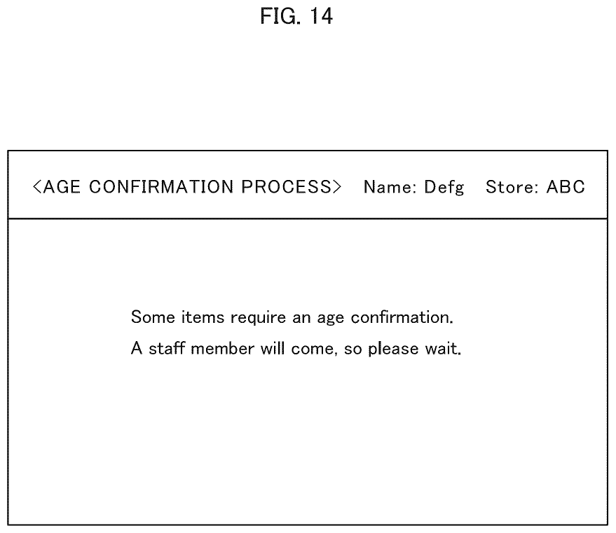

Next, the checkout machine 5 determines whether or not the items to be purchased listed in the payment information include the age confirmation item (step S321). When no age confirmation item is included (step S321: No), the checkout process advances to step S324. On the other hand, when the age confirmation item is included (step S321: Yes), the checkout machine 5 displays an age confirmation screen (step S322). FIG. 14 illustrates a display example of the age confirmation screen. As illustrated, the age confirmation screen includes a message indicating that the age confirmation is performed by a clerk. Incidentally, at the same time as displaying the age confirmation screen, the checkout machine 5 may turn on the light 57 or output a sound from the speaker 58.

When the age confirmation screen is displayed, the clerk comes to the checkout machine 5 to check the age of the customer. Specifically, the clerk looks at the customer, who is accounting at the checkout machine 5 in order to check the age of the customer, and if there is no problem, the clerk scans a clerk barcode printed on a clerk card by the barcode reader 56 of the checkout machine 5. Incidentally, the clerk barcode is an example of the age confirmation information. Upon scanning the clerk barcode, the checkout machine 5 determines that the age confirmation is completed (step S323), and displays the payment method selection screen (step S324). After the age confirmation is completed, processes as the same as those in FIG. 10 are performed. That is, the steps S324 through S326 are the same as the steps S308 through S310 in FIG. 10, and explanations thereof will be omitted.

As described above, in a case where the age confirmation item is included in the items to be purchased by the customer, the checkout machine 5 determines that the age confirmation is completed when the clerk barcode is scanned. Therefore, since the clerk actually looks at the customer to check the age, it is possible to accurately confirm the age.

### Second Example Embodiment

In the second example embodiment, it is basically assumed that the customer performs a credit payment using the mobile terminal 3. A customer may register credit card information at a member registration or the like for a store operation company or may register the credit card information for a payment agency with which the store has a contract, so as to be able to make a credit payment using the mobile terminal 3 of the customer. However, in a case where items to be purchased include an age confirmation item, since the credit payment cannot be made by the mobile terminal 3, the age is checked at the checkout machine 5 and the payment is made by the checkout machine 5.

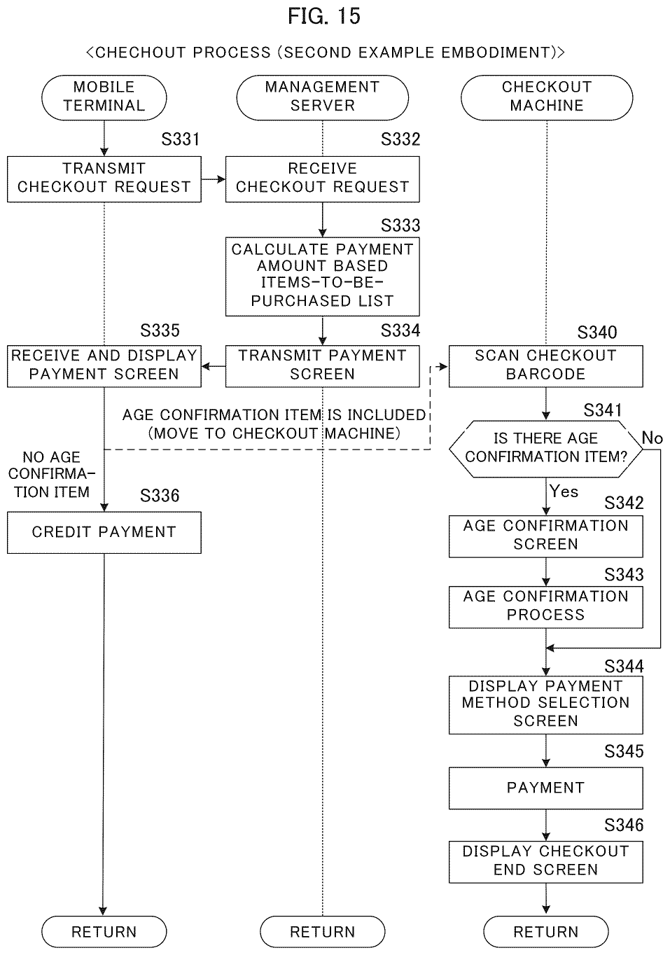

FIG. 15 illustrates a flowchart of the checkout process in a case of performing the age confirmation. First, when the payment button 45 is pressed in the items-to-be-purchased list screen illustrated in FIG. 9, the mobile terminal 3 transmits a checkout request to the management server 2 (step S331). When receiving the checkout request (step S332), the management server 2 calculates a payment amount based on the items-to-be-purchased list at that time (step S333), and generates a payment screen and transmits the payment screen to the mobile terminal 3 (step S334). Here, the management server 2 generates a different payments screen depending on whether or not the age confirmation item is included in the items-to-be-purchased list.

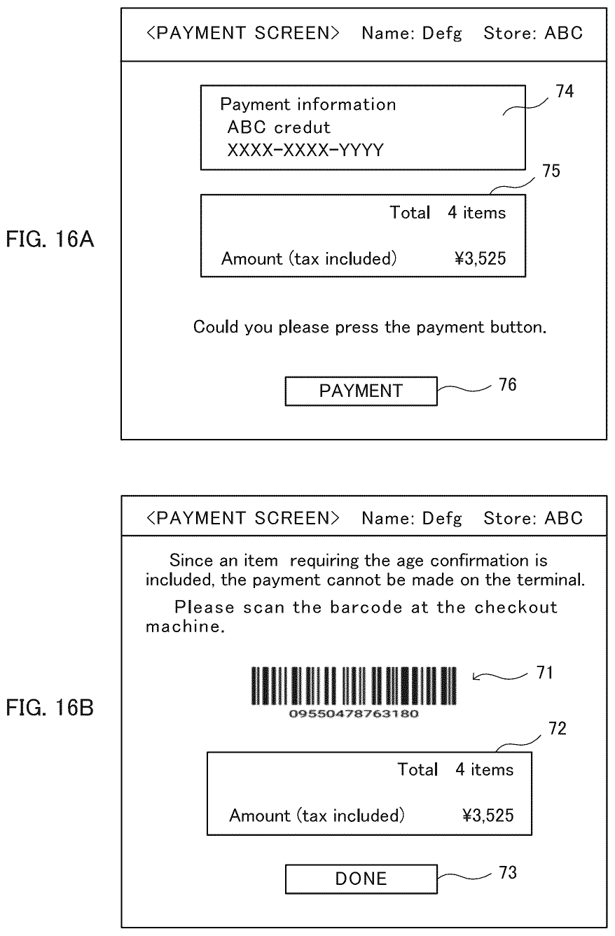

FIG. 16A is a display example of the payment screen in a case where the age confirmation item is not included. In this example, the payment screen includes a payment information column 74, a total amount column 75, and a payment button 76. The payment information column 74 includes a credit company name and a credit card number for making a credit payment. The total amount column 75 indicates a total amount of items to be purchased. The payment button 76 is a button for a customer to instruct an execution of the credit payment. Incidentally, in a case where a personal identification number or a security code is required to be input depending on the credit company, or the like, an input field is provided.

FIG. 16B is a display example of the payment screen in a case where the age confirmation item is included. In this case, a message (hereinafter, referred to as an “age confirmation message”), which indicates that the credit payment cannot be made because the age confirmation item is included and urging performing the checkout process at the checkout machine 5, is displayed on the payment screen. In addition, in order to perform the checkout process at the checkout machine 5, the management server 2 generates the checkout barcode 71 and includes the checkout barcode 71 in the payment screen. Furthermore, the total amount column 72 and the completion button 73 are displayed on the payment screen.

The mobile terminal 3 displays the received payment screen on the display unit 31 (step S335). When the items to be purchased do not include the age confirmation item, the customer performs an input to the payment screen illustrated in FIG. 16A, and the mobile terminal 3 executes a credit payment (step S336). On the other hand, in a case where the items to be purchased include the age confirmation item, the customer moves to the checkout machine 5 and operates the checkout machine 5 to make a payment.

In the checkout machine 5, processes for performing the age confirmation and a payment are the same as those in the first example embodiment. That is, processes of steps S340 through S346 are the same as processes of the steps S320 through S326 illustrated in FIG. 13, and explanations thereof will be omitted. Incidentally, the customer can select a payment by a credit card on the payment method selection screen displayed in step S344.

[Modifications]

(Modification 1)

In the above-described example embodiment, the checkout machine 5 may confirm the presence or absence of an age confirmation item based on the payment information which is decoded from the payment information or the checkout barcode 71 received from the management server 2. Instead, the management server 2 may determine the presence or absence of the age confirmation item. In this case, when a customer scans the checkout barcode 71 at the checkout machine 5, the checkout machine 5 transmits information of the checkout barcode 71 to the management server 2 to request the presence or absence of the age confirmation item. In a case where the age confirmation item is included, the management server 2 transmits an age confirmation screen to the checkout machine 5 to display. Accordingly, a clerk barcode is scanned at the checkout machine 5, when the checkout machine 5 reports scanning of the clerk barcode to the management server 2, the management server 2 terminates the age confirmation process, and transmits the paying method selection screen, so that the paying method selection screen is displayed on the checkout machine 5. On the other hand, in a case where the age confirmation item is not included, the management server 2 does not transmit the age confirmation screen and transmits the paying method selection screen to the checkout machine 5 to display. Accordingly, it is possible to perform the age confirmation in the same manner as in the above-described example embodiment.

(Modification 2)

In the above-described example embodiment, the clerk who has confirmed the age of the customer scans the clerk barcode at the checkout machine 5; instead, the age confirmation may be conducted by biometrics using biometric information of the customer. In this case, the biometric information (face, fingerprint, or the like) of the customer is registered in advance at the time of a member registration of the customer, or the like. A camera is provided in the checkout machine 5, the biometric information is captured by the customer when the age confirmation screen is displayed and is transmitted to the management server 2. The management server 2 compares the biometric information transmitted from the checkout machine 5 with the biometric information registered in advance, and the age confirmation may be conducted based on age information of the customer registered as a member when both sets of the biometric information match with each other. In this case, the biometric information is an example of the age confirmation information.

(Modification 3)

In the above-described example embodiment, a barcode applied to a product is scanned by the mobile terminal 3; however, instead, a QR (Quick Response) code may be applied to the product and may scan the QR code by the mobile terminal 3.

A part or all of the example embodiments described above may also be described as the following supplementary notes, but not limited thereto.

(Supplementary Note 1)

1. A purchase management system comprising:
a server apparatus; and
a checkout machine,
wherein the server apparatus includes
   an item identification information acquisition unit configured to receive item identification information, which is scanned from a code attached to each item, from a mobile terminal,
   a list creation unit configured to create a list of items to be purchased based on the item identification information received from the mobile terminal, and
   a checkout information generation unit configured to generate checkout information based on the list of items to be purchased and transmit the checkout information to the mobile terminal, and
wherein the checkout machine includes
   a list acquisition unit configured to acquire the checkout information from the mobile terminal, and acquire the list of items to be purchased based on the checkout information,
   a display control unit configured to display an age confirmation screen when an item requiring an age confirmation is included in the list of items to be purchased,
   an age confirmation information acquisition unit configured to acquire age confirmation information, and
   an age confirmation unit configured to complete the age confirmation when the age confirmation information is acquired by the age confirmation information acquisition unit.

(Supplementary Note 2)

2. The purchase management system according to supplementary note 1, wherein the server apparatus further includes a checkout screen information generation unit configured to generate checkout screen information and transmit the checkout screen information to the mobile terminal, the checkout screen information including the checkout information when the item requiring the age confirmation is not included in the list of items to be purchased and including the checkout information and an age confirmation message when the item requiring the age confirmation is included in the list of items to be purchased.

(Supplementary Note 3)

3. The purchase management system according to supplementary note 1 or 2, wherein the display control unit displays the age confirmation screen when a specific code is included in the item identification information of an item listed in the list of items to be purchased.

(Supplementary Note 4)

4. The purchase management system according to supplementary note 1 or 2, wherein
the checkout machine stores a list of items requiring the age confirmation which indicates item identification information of the items requiring the age confirmation, and
the display control unit displays the age confirmation screen when item identification information of an item listed in the list of items to be purchased is included in the list of items requiring the age confirmation.

(Supplementary Note 5)

5. The purchase management system according to any one of supplementary notes 1 through 4, wherein the age confirmation information indicates a clerk code applied on a possession of a clerk.

(Supplementary Note 6)

6. The purchase management system according to supplementary note 5, wherein the checkout machine performs at least one of outputting sound and turning on a light.

(Supplementary Note 7)

7. The purchase management system according to any one of supplementary notes 1 through 4, wherein the age confirmation information indicates biometric information of a customer.

(Supplementary Note 8)

8. A purchase management method performed by a purchase management system comprising a server apparatus and a checkout machine,
wherein the server apparatus performs
   receiving item identification information, which is scanned from a code attached to each item, from a mobile terminal,
   creating a list of items to be purchased based on the item identification information received from the mobile terminal, and
   generating checkout information based on the list of items to be purchased, and transmitting the checkout information to the mobile terminal, and
wherein the checkout machine performs
   acquiring the checkout information from the mobile terminal, and acquiring the list of items to be purchased based on the checkout information,
   displaying an age confirmation screen when an item requiring an age confirmation is included in the list of items to be purchased,
   acquiring age confirmation information, and
   completing the age confirmation when the age confirmation information is acquired.

(Supplementary Note 9)

9. A server apparatus capable of communicating with a mobile terminal and a checkout machine, the server apparatus comprising:
an item identification information acquisition unit configured to receive item identification information scanned from a code attached to each item, from the mobile terminal;
a list creation unit configured to create a list of items to be purchased based on the item identification information received from the mobile terminal;
a checkout information generation unit configured to generate checkout information based on the list of items to be purchased, and transmit the checkout information to the mobile terminal;
a list acquisition unit configured to receive checkout information from the checkout machine, and acquire the list of items to be purchased based on the checkout information;
a display control unit configured to display an age confirmation screen on the checkout machine when an item requiring an age confirmation is included in the list of items to be purchased;
an age confirmation unit configured to complete the age confirmation when age confirmation information is received from the checkout machine.

(Supplementary Note 10)

10. A recording medium storing a program, the program causing a computer to perform a process comprising:
receiving item identification information scanned from a code attached to each item, from the mobile terminal;
creating a list of items to be purchased based on the item identification information received from the mobile terminal;
generating checkout information based on the list of items to be purchased and transmitting the checkout information to the mobile terminal;
receiving checkout information from a checkout machine, and acquiring the list of items to be purchased;
displaying an age confirmation screen on the checkout machine when an item requiring an age confirmation is included in the list of items to be purchased; completing the age confirmation when age confirmation information is received from the checkout machine.

While the disclosure of the present application has been described above with reference to the example embodiments, the disclosure of the present application is not limited to the above-described embodiment. Various changes that can be understood by those skilled in the art can be made within the scope of the present disclosure in terms of the configuration and details of the present disclosure. That is, it goes without saying that the disclosure of the present application includes all disclosure including claims, various modifications and modifications that can be made by those skilled in the art in accordance with the technical idea. In addition, each disclosure of the above-mentioned patent documents cited is incorporated into this document by citation.

This application claims priority on the basis of Japanese Patent Application No. 2019-191751 filed on Oct. 21, 2019 and incorporates all of its disclosures herein.

### DESCRIPTION OF SYMBOLS

1 POS server
2 Management server
3 Mobile terminal
5 Checkout Machine
56 Barcode reader
71 Checkout barcode
100 Purchase management system

What is claimed is:

1. A purchase management system comprising:
a server apparatus including a first memory storing first instructions, and one or more first processors; and
a checkout machine including a second memory storing second instructions, and one or more second processors configured to execute the second instructions,
wherein the one or more first processors are configured to execute the first instructions to
receive item identification information, which is scanned from a code attached to each item, from a mobile terminal,
create a list of items to be purchased based on the item identification information received from the mobile terminal, and
generate checkout information based on the list of items to be purchased and transmit the checkout information to the mobile terminal, and
wherein the one or more second processors are configured to execute the second instructions to
acquire the checkout information from the mobile terminal, and acquire the list of items to be purchased based on the checkout information,
display an age confirmation screen when an item requiring an age confirmation is included in the list of items to be purchased,
acquire age confirmation information, and
complete the age confirmation when the age confirmation information is acquired.

2. The purchase management system according to claim 1, wherein the first processor generates checkout screen information and transmit the checkout screen information to the mobile terminal, the checkout screen information including the checkout information when the item requiring the age confirmation is not included in the list of items to be purchased and including the checkout information and an age confirmation message when the item requiring the age confirmation is included in the list of items to be purchased.

3. The purchase management system according to claim 1, wherein the second processor displays the age confirmation screen when a specific code is included in the item identification information of an item listed in the list of items to be purchased.

4. The purchase management system according to claim 1, wherein
the checkout machine stores, in the second memory, a list of items requiring the age confirmation which indicates item identification information of the items requiring the age confirmation, and
the second processor displays the age confirmation screen when item identification information of an item listed in the list of items to be purchased is included in the list of items requiring the age confirmation.

5. The purchase management system according to claim 1, wherein the age confirmation information indicates a clerk code applied on a possession of a clerk.

6. The purchase management system according to claim 5, wherein the second processor performs at least one of outputting sound and turning on a light.

7. The purchase management system according to claim 1, wherein the age confirmation information indicates biometric information of a customer.

8. A purchase management method performed by a purchase management system comprising a server apparatus and a checkout machine,
wherein the server apparatus performs
receiving item identification information, which is scanned from a code attached to each item, from a mobile terminal,
creating a list of items to be purchased based on the item identification information received from the mobile terminal, and
generating checkout information based on the list of items to be purchased, and transmitting the checkout information to the mobile terminal, and
wherein the checkout machine performs
acquiring the checkout information from the mobile terminal, and acquiring the list of items to be purchased based on the checkout information,
displaying an age confirmation screen when an item requiring an age confirmation is included in the list of items to be purchased,
acquiring age confirmation information, and
completing the age confirmation when the age confirmation information is acquired.

9. A server apparatus capable of communicating with a mobile terminal and a checkout machine, the server apparatus comprising:
a memory storing instructions; and
one or more processors configured to execute the instructions to:
receive item identification information scanned from a code attached to each item, from the mobile terminal;
create a list of items to be purchased based on the item identification information received from the mobile terminal;
generate checkout information based on the list of items to be purchased, and transmit the checkout information to the mobile terminal;
receive checkout information from the checkout machine, and acquire the list of items to be purchased based on the checkout information;
display an age confirmation screen on the checkout machine when an item requiring an age confirmation is included in the list of items to be purchased;
complete the age confirmation when age confirmation information is received from the checkout machine.

10. (canceled)
